(19) United States
(12) Patent Application Publication
(10) Pub. No.: US 2012/0218156 A1
(43) Pub. Date: Aug. 30, 2012

(54) ON-FREQUENCY REPEATER

(75) Inventor: Alireza Hormoz Mohammadian, San Diego, CA (US)

(73) Assignee: QUALCOMM Incorporated, San Diego, CA (US)

(21) Appl. No.: 13/222,803

(22) Filed: Aug. 31, 2011

Related U.S. Application Data
(60) Provisional application No. 61/379,214, filed on Sep. 1, 2010.

(51) Int. Cl. H01Q 21/00; H01Q 1/50

(52) U.S. Cl. 343/730; 343/816

(57) ABSTRACT

An on-frequency repeater includes: an electrical conductor groundplane having first and second opposing surfaces on first and second sides of the groundplane, respectively; and an antenna system including directional antennas of different types, the antenna system including: a donor antenna array including donor dipoles disposed on the first side of the groundplane and displaced a first distance from the first surface, the donor dipoles being disposed parallel to each other; a coverage antenna array including a plurality of coverage dipoles disposed on the second side of the groundplane and displaced a second distance from the second surface, the coverage dipoles being disposed parallel to each other and transverse to the donor dipoles; a quantity of baluns and a corresponding quantity of feed conductors extending away from the groundplane and configured to electromagnetically feed respective ones of the donor dipoles and coverage dipoles.

### CROSS-REFERENCE TO RELATED APPLICATIONS

This application claims the benefit of U.S. Provisional Application No. 61/379,214, filed Sep. 1, 2010, entitled “ANTENNA SYSTEM WITH HIGH ISOLATION FOR UMTS REPEATERS” which is hereby incorporated by reference in its entirety.

### BACKGROUND

Wireless communications have increased in use and demand throughout the world. To keep up with the demand, wireless communication networks have been developed, implemented, and expanded.

In spite of the extensive wireless networks available today in many parts of the world, even in the large metropolitan areas there are still regions where indoor wireless signal coverage is weak and unreliable. To alleviate this problem, low cost, self installable, on-frequency repeaters can be used that provide very high gain and low insertion delay. One of the main challenges in designing such a repeater is the high isolation that is desired between the output and the input ports of the repeater. The isolation can partly be provided by echo cancellation techniques at the baseband, and partly by an antenna system designed to provide large isolation between donor and coverage apertures.

### SUMMARY

An example of an on-frequency repeater includes: a groundplane having first and second opposing surfaces on first and second sides of the groundplane, respectively, the groundplane including an electrical conductor; and an antenna system including directional antennas of different types, the antenna system including: a donor antenna array including donor dipoles disposed on the first side of the groundplane and displaced a first distance from the first surface, the donor dipoles being disposed parallel to each other; a coverage antenna array including a plurality of coverage dipoles disposed on the second side of the groundplane and displaced a second distance from the second surface, the coverage dipoles being disposed parallel to each other and transverse to the donor dipoles; a quantity of baluns and a corresponding quantity of feed conductors extending away from the groundplane and configured to electromagnetically feed respective ones of the donor dipoles and coverage dipoles.

Implementations of such a repeater may include one or more of the following features. The donor dipoles each include a rectangular planar conductor disposed in a plane transverse to a plane of the first surface, and the coverage dipoles each include a rectangular planar conductor disposed in a plane transverse to a plane of the second surface. Each of the dipoles is a balanced dipole defining a slot bisecting the planar conductor, and the respective feed conductors traverse and excite the respective slots. Each of the baluns extends from the respective dipole toward the groundplane and defines the respective slot from the dipole toward the groundplane, and each of the feed conductors extends away from the groundplane toward the respective dipole on a first side of the respective slot and traverses the slot while overlapping a portion of the respective dipole. Each of the feed conductors traverses the respective slot near a proximal edge of the respective dipole, the proximal edge being closer to the groundplane than a distal edge of the respective dipole. Each of the feed conductors has a J shape, extending toward the groundplane on a second side of the respective slot, opposite the first side of the respective slot.

Also or alternatively, examples of such a repeater may include or more of the following features. The donor dipoles and the coverage dipoles are configured to have lower return losses inside a range of frequencies from 1920 MHz-2170 MHz than outside the range of frequencies, and both the donor antenna array and the coverage antenna array provide at least 10 dB of return loss over the range of frequencies. Each of the donor and coverage dipoles and the respective balun are disposed on a sheet of dielectric material. Respective first portions of the dielectric material on which the baluns are disposed have a first dielectric constant value and respective second portions of the dielectric material on which the dipoles are disposed have a second dielectric constant value, the first and second dielectric constant values being different.

Another example of an on-frequency repeater includes: a groundplane structure providing an internal cavity and having first and second opposing conductive surfaces on first and second sides of the groundplane structure, respectively; a donor antenna system disposed on the first side of the groundplane, the donor antenna system having a first directional antenna pattern; and a coverage antenna system disposed on the second side of the groundplane, the coverage antenna system having a second directional antenna pattern; where at least one of the donor antenna system or the coverage antenna system includes a dipole antenna electrically coupled to a balun where the dipole antenna includes a first planar conductor disposed on a dielectric structure and the balun includes a second planar conductor disposed on the same dielectric structure.

Implementations of such a repeater may include one or more of the following features. The dipole antenna is disposed on a first portion of the dielectric structure having a first dielectric constant value and at least a portion of the balun is disposed on a second portion of the dielectric structure having a second dielectric constant value, the first and second dielectric constant values being different. The repeater further includes a quantity of amplifiers and an echo canceller, all electrically coupled to the donor and coverage antenna systems, where the amplifiers and the echo canceller are housed in the groundplane structure.

Items and/or techniques described herein may provide one or more of the following capabilities, as well as other capabilities not mentioned. On-frequency, low cost, self-installable repeaters with very high gain and low insertion delay can be provided. On-frequency repeaters can be provided with about 80 dB of isolation or more and about 80 dB of gain or more over UMTS bands, with about 10 dB or more of the gain provided by the antennas of the repeaters. On-frequency repeaters can be provided with relatively low profiles. Further, it may be possible for an effect noted above to be achieved by means other than that noted, and a noted item/technique may not necessarily yield the noted effect. The complexity of echo cancellation algorithms and the related hardware in the baseband can be reduced, saving cost.

### BRIEF DESCRIPTIONS OF THE FIGURES

FIG. 1 is a simplified diagram of a wireless communication system including a base station controller, base stations, repeaters, and access terminals.

FIG. 2 is a simplified block diagram of a repeater shown in FIG. 1.

FIG. 3 is a top perspective view of a first antenna configuration of the repeater shown in FIG. 2.

FIG. 4 is a bottom perspective view of the antenna configuration shown in FIG. 3.

FIG. 5 is a perspective view of a dipole antenna and a portion of a feed arrangement for the dipole antenna of the antenna configuration shown in FIG. 3.

FIG. 6 is a block flow diagram of a process of repeating signals using the repeater shown in FIGS. 3-5.

FIG. 7 is a graph of lab-measured s-parameters for the antenna configuration shown in FIG. 3.

FIG. 8 is a graph of freespace return loss for a coverage antenna shown in FIG. 3.

FIG. 9 is a graph of freespace return loss for a donor antenna shown in FIG. 3.

FIG. 10 is a graph of freespace isolation between the coverage antenna and the donor antenna shown in FIG. 3.

FIG. 11 is a graph of peak gain of the coverage antenna and the donor antenna shown in FIG. 3.

FIG. 12 is a histogram of statistical isolation data collected in various locations in an enterprise environment between the coverage antenna and the donor antenna shown in FIG. 3.

FIG. 13 is a top perspective view of a second antenna configuration of the repeater shown in FIG. 2.

FIG. 14 is a plan view of a dielectric structure containing a balun feed mechanism and a dipole antenna of the antenna configuration shown in FIG. 13.

FIG. 15 is a graph of lab-measured s-parameters for the antenna configuration shown in FIG. 13.

FIG. 16 is a graph of freespace return loss for the antenna configuration shown in FIG. 13.

FIG. 17 is a graph of freespace isolation between a coverage antenna array and a donor antenna array shown in FIG. 13.

FIG. 18 is a graph of measured peak gains of dipole antenna arrays shown in FIG. 13.

### DETAILED DESCRIPTION

Techniques are provided for providing isolation between donor and coverage antenna apertures in an on-frequency repeater, e.g., for wireless communications. For example, a first example antenna system includes two antennas on opposite sides of a groundplane, e.g., a thin box or sheet groundplane. A donor antenna for communication with a base station is an E-shaped patch radiator separated from and parallel to one side of the groundplane. Separated from and extending transverse to another side of the groundplane is a balanced dipole radiator that is the coverage antenna. The coverage antenna and the patch antenna extend different distances from the groundplane (have different profiles), with the patch antenna having a lower profile than the dipole antenna. The dipole antenna is center fed by a microstrip line, which is in turn fed by a coaxial line attached to the groundplane. The patch antenna is fed by a strip conductor that is in turn fed by a coaxial line that is attached to the groundplane. The coaxial line feeding the patch antenna can be located on the same side of the groundplane as the coaxial line feeding the dipole antenna. In particular, antenna system designs and usage are described for a Universal Mobile Telecommunications System (UMTS) repeater.

Other configurations are within the scope of the disclosure. For example, a second example antenna system includes two 2-dipole antenna arrays. The arrays are disposed on opposite sides of groundplane, e.g., a thin box or sheet groundplane. Each array has two dipoles disposed parallel to each other and separated from respective sides of the groundplane, with the dipoles of one array being transverse to the dipoles of the other array. One array serves as a part of a donor antenna system for communication with a base station. The other array has its dipoles extending transverse to the dipoles of the first array. The dipole antennas are center fed by microstrip line baluns. In particular, antenna system designs and usage are described for a Universal Mobile Telecommunications System (UMTS) repeater. Still other configurations are possible.

Techniques described herein may be used for various wireless communication systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95 and IS-856 standards. IS-2000 Releases 0 and A are commonly referred to as CDMA2000 1x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

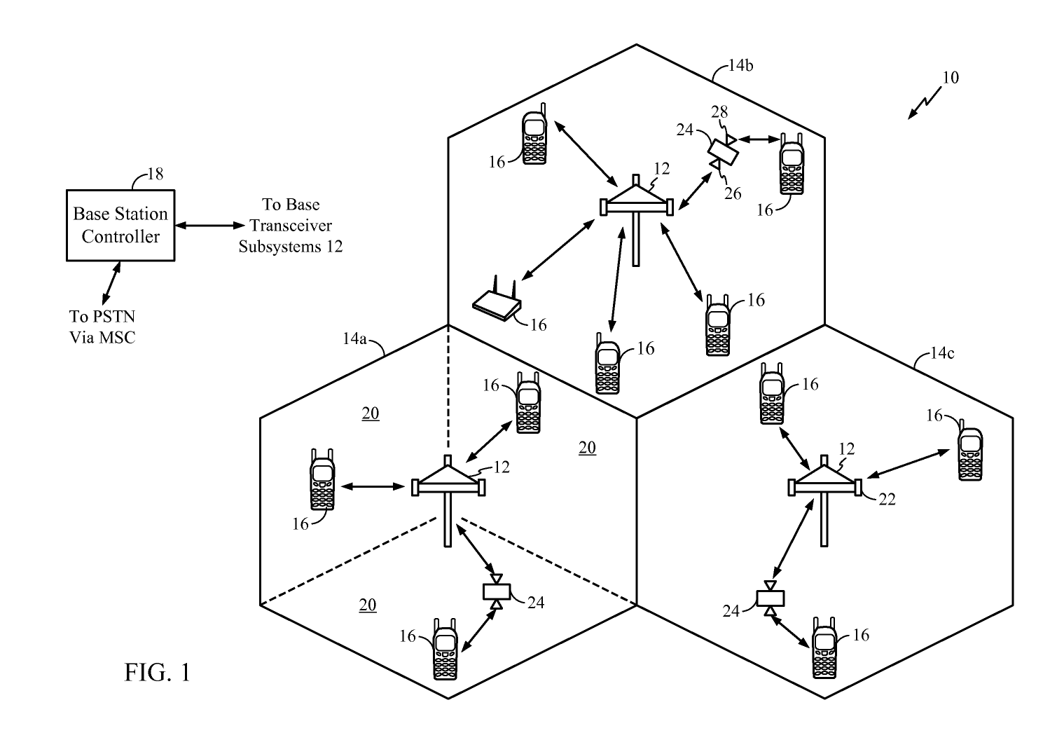

Referring to FIG. 1, a wireless communication system 10 includes base transceiver stations (BTSs) 12, disposed in cells 14, mobile access terminals 16 (ATs), a base station controller (BSC) 18, and on-frequency repeaters 24. The BTSs 12 and ATs 16 communicate bi-directionally via modulated signals. Each modulated signal may be a CDMA signal, a TDMA signal, an OFDMA signal, a SC-FDMA signal, etc. Each modulated signal may carry pilot, overhead information, data, etc. The BTSs 12 may also be referred to as an access point, an access node (AN), a Node B, an evolved Node B (eNB), etc. The ATs 16 may be referred to as mobile stations, mobile devices, user equipment (UE), or subscriber units. The wireless communication system 10 does not have all communications transmitted wirelessly, but is configured to have at least some communications transmitted wirelessly.

The BTSs 12 can wirelessly communicate with the terminals 16 via antennas 22. The BTS 12 may also be referred to as an access point, an access node (AN), a Node B, an evolved Node B (eNB), etc. The BTSs 12 are configured to communicate with the ATs 16 under the control of the BSC 18. While a BSC 18 is shown, and is separate from the BTSs 12, other configurations are possible (e.g., the controller for a Node B is known as a radio network controller (RNC), and an eNB contains both transceiver and controller, i.e., both BTS and BSC functionality). Each of the base stations 12 can provide communication coverage for a respective geographic area, here the cell 14a, 14b, or 14c. Each of the cells 14 of the base stations 12 is partitioned into multiple (here three) sectors 20 (as shown in cell 14a) as a function of the base station antenna 22. While FIG. 1 shows the sectors 20 as being sharply defined, with the ATs being in only one sector 20 each, the sectors 20 overlap and a single AT 16 can be in multiple sectors 20 and multiple cells 14 simultaneously such that the BTSs 12 can communicate with the AT 16 through more than one sector 20 and more than one cell 14.

The system 10 may include only macro base stations 12 or it can have base stations 12 of different types, e.g., macro, pico, and/or femto base stations. A macro base station may cover a relatively large geographic area (e.g., several kilometers in radius) and may allow unrestricted access by terminals with service subscription. A pico base station may cover a relatively small geographic area (e.g., a pico cell) and may allow unrestricted access by terminals with service subscription. A femto or home base station may cover a relatively small geographic area (e.g., a femto cell) and may allow restricted access by terminals having association with the femto cell (e.g., terminals for users in a home).

The ATs 16 can be dispersed throughout the cells 14. The ATs 16 may be referred to as mobile stations, mobile devices, user equipment (UE), or subscriber units. The ATs 16 here include cellular phones and a wireless communication device, but can also include personal digital assistants (PDAs), other handheld devices, netbooks, notebook computers, etc.

The repeaters 24 are on-frequency repeaters in that a signal is received by the repeater 24, amplified, and transmitted by the repeater 24 with the same frequency as the received signal. Being designed for use in a UMTS network, the repeater 24 operates with desired characteristics over the 1920 MHz-1980 MHz and 2110 MHz-2170 MHz bands (collectively the UMTS band), thus having a 250 MHz bandwidth. Antennas of the repeater 24 are designed to have desired gain, e.g., at least 10 dB, and desired isolation, here 80 db to avoid oscillation, over the UMTS band.

The repeaters 24 each include a donor antenna 26 to communicate with the BTSs 12 and a coverage antenna 28 to communicate with the ATs 16, e.g., within an enclosed, poor-coverage area such as an office building. The repeaters 24 are network devices that receive signals from one or more BTSs 12, and retransmit substantially the same signals to one or more of the ATs 16. The donor antenna 26 and the coverage antenna 28 are both directional antennas, as opposed to omnidirectional antennas, being configured to radiate greater power in one or more directions than other directions. The repeaters 24 are typically used to extend the range of one or more of the BTSs 12. For example, the repeaters 24 can be placed in locations with good connectivity to respective BTSs 12 (e.g., at the crest of a hill or an outer edge of a building), and provide coverage to areas with poorer connectivity (e.g., in a valley, or an interior of a building). The repeaters 24 communicate with the BTSs 12 through the donor antennas 26 and communicate with the ATs 16 through the coverage antennas 28. Repeaters are commonly considered cost-effective mechanisms for extending or improving network coverage. In particular, the use of repeaters can effectively broaden the geographical coverage area associated with a given base station. Moreover, the cost of implementing a repeater can be significantly less than the cost of adding an additional base station.

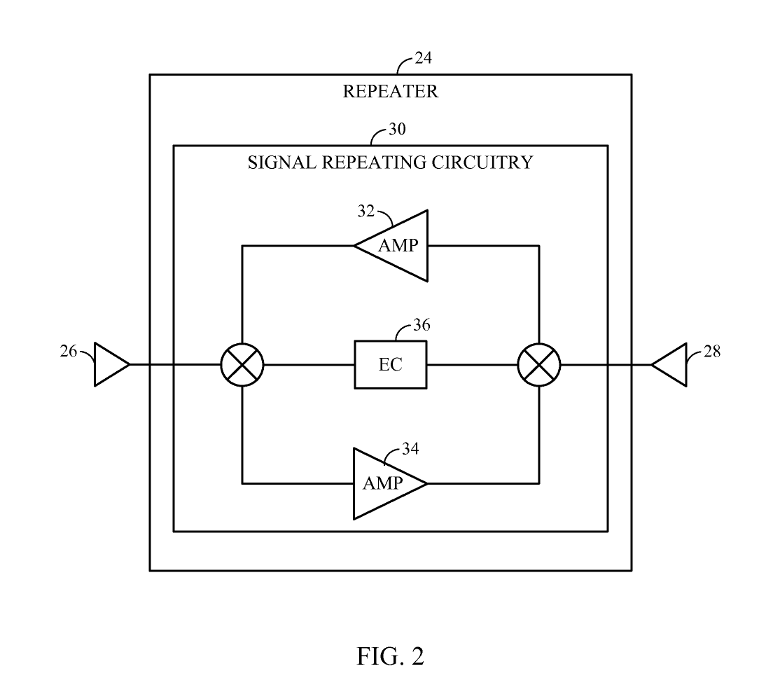

Referring to FIG. 2, an example of one of the repeaters 24 includes the donor antenna 26, the coverage antenna 28, and signal repeating circuitry 30, which may be contained in a housing that may provide groundplane surfaces. The components of the repeater 24 are shown in simplified form, and many components are omitted for the sake of clarity and simplicity. The signal repeating circuitry 30 includes an uplink amplifier 32 and a downlink amplifier 34. The repeater 24 is configured to receive a signal sent from a BTS 12 through the donor antenna 26, amplify the received signal with the amplifier 34, and repeat/transmit the amplified signal, having the same frequency as the received signal, to an AT 16 through the coverage antenna 28. Similarly, the repeater 24 is configured to receive a signal sent from an AT 16 through the coverage antenna 28, amplify the received signal with the amplifier 32, and repeat/transmit the amplified signal, having the same frequency as the received signal, to a BTS 12 through the donor antenna 26. The repeater 24 preferably provides about 80 dB of gain, with about 10 dB or more provided by the antennas 26, 28. Further, to help mitigate oscillations, to provide a stable, non-oscillating repeater, the antennas 26, 28 preferably have at least about 80 dB of isolation. Some of this isolation is provided by echo cancellation circuitry 36 connected to the antennas 26, 28, and some is provided by the antennas 26, 28 and other physical configuration of the repeater 24.

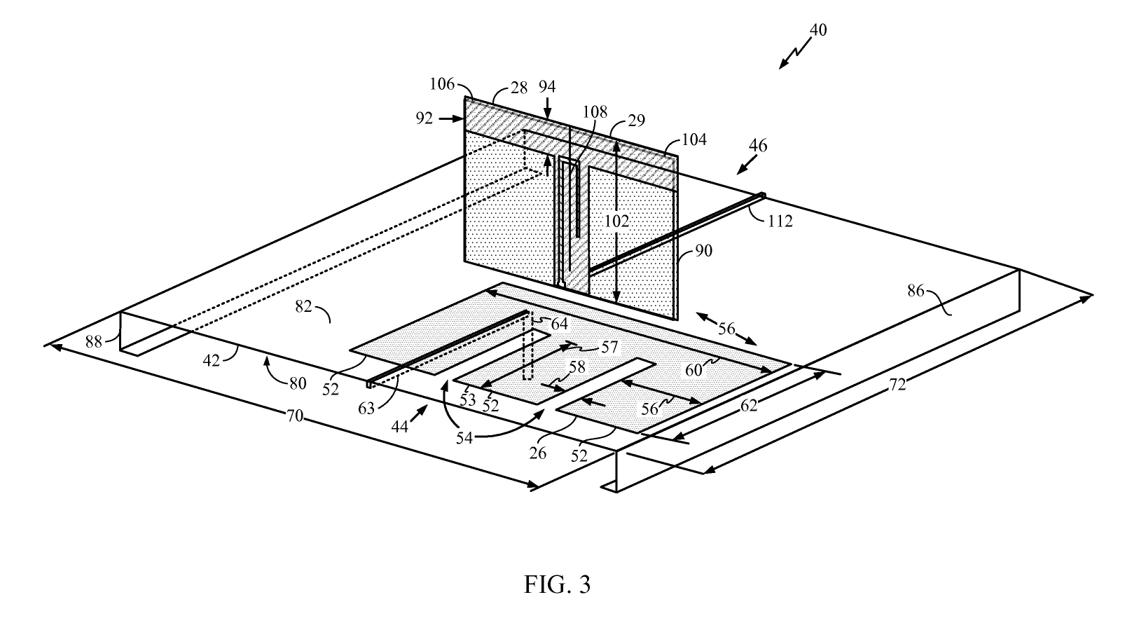

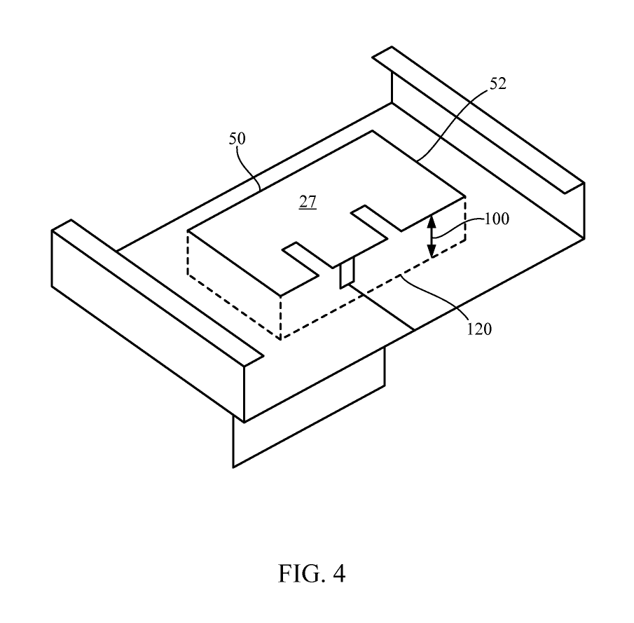

Referring to FIGS. 3-4, an antenna configuration 40 of the repeater 24 includes the donor antenna 26, the coverage antenna 28, a groundplane 42, a donor antenna feed arrangement 44, and a coverage antenna feed arrangement 46. The donor antenna 26 is disposed on one side of the groundplane 42 and the coverage antenna 28 is disposed on the opposite side of the groundplane 42. In the following description, dimensions and materials are provided for an example of the antenna configuration 40 for a UMTS repeater configured for operation with desired characteristics in an uplink, AT-transmit (UE-receive), frequency band of 1920 MHz-1980 MHz and a downlink, AT-receive (UE-receive), frequency band of 2110 MHz-2170 MHz. The antenna configuration will thus have a bandwidth of at least 250 MHz. The dimensions and materials provide an example only and other applications of the antenna configuration 40 are possible. Further, while the groundplane 42 is shown as a folded metal sheet, other configurations are possible such as the groundplane being provided by a conductive box. In this case, repeater electronics may be housed in the box.

The donor antenna 26 comprises an E-shaped patch antenna radiator. The antenna 26 comprises an E-shaped planar conductor such as a stamped, cut, or otherwise formed portion of a conductive sheet of metal such as copper. Design parameters for the patch antenna 26 include the location of the feed point, width of a feed probe, and dimensions of the patch. The radiator 26 has a base portion 50 and three prongs 52 separated by gaps 54. The prongs 52 have widths 56 that are substantially larger than widths 58 of the gaps 54. For example, the widths 56 may be about four times the widths 58. For a UMTS example, the widths 56 may be about 25.2 mm and the widths 58 about 6.3 mm. Further, for the UMTS example, lengths 57 of the prongs 52 may be about 37.8 mm. The radiator 26 is centered with respect to the groundplane 42 such that an axis bisecting a length 60 of the radiator 26 is coincident with an axis bisecting a length 70 of the groundplane 42, and an axis bisecting a width 62 of the radiator is coincident with an axis bisecting a width 72 of the groundplane 42. For example, the length 60 may be about 88.2 mm and the width 62 may be about 56.7 mm for use in a UMTS system. The E-shaped patch radiator 26 is fed by a strip conductor 64 in a middle of the width 56 of the middle prong 52. For example, the conductor 64 can be connected to the middle prong 52 about 15.6 mm from an end 53 of the middle prong 52. The radiator 26 is planar, displaced from the groundplane 42, and substantially parallel (e.g., within manufacturing tolerances) to a bottom surface or face 80 of the groundplane 42. The radiator 26 is maintained in its displaced position by a spacer 120 (shown in dashed lines in FIG. 4) made of a low-dielectric material, such as a foam, a plastic, etc., disposed between the radiator 26 and the groundplane 42, but this material is not shown in FIG. 2 for the sake of clarity to help illustrate the radiator and the groundplane 42. The antenna 28 can be made out of sheet metal suspended over the ground plane by Styrofoam or other types of plastic spacers. The stamped metal can also be attached to the ceiling of a plastic cover (or box) over the antenna which can also serve as a radome. Alternatively, the antenna 28 can be etched on a dielectric substrate. For a UMTS example, a distal surface 27 of the radiator 26, i.e., the surface of the radiator 26 that is further from the groundplane 42, could be displaced from the bottom surface 80 by a distance 100 about 11.8 mm.

The donor antenna feed arrangement 44 comprises a coaxial cable 63 and the strip conductor 64. The cable 63 can be attached, e.g., soldered, to the groundplane 42. Other feed mechanisms such as a microstrip line could be used instead of the coaxial cable 63. Further, the strip conductor 64 could be replaced by a section of coaxial cable with a center conductor of the coaxial cable electrically connected to the radiator 26 to excite the radiator 26. The coaxial line 63 is attached to a top surface 82 of the groundplane 42, with a center conductor of the coaxial line extending through the groundplane 42, and electrically coupled, to the strip conductor 64. The strip conductor may have, for example, a width of about 3 mm, e.g., for a UMTS implementation. If a box groundplane is used, the coaxial line 63 could extend internally to the box, e.g., on an inner surface of a bottom wall and extend through the bottom wall to excite the strip conductor 64 to in turn excite the radiator 26 that would be displaced from the bottom wall of the box groundplane. Alternatively, a probe that feeds the patch antenna 26 can be connected to a circuit board containing radio frequency (RF) components within the electronics box, and a microstrip, a coplanar waveguide, or a stripline can be connected to transmit/receive (TX/RX) units (not shown).

The groundplane 42 separates the donor antenna 26 from the coverage antenna 28 to help the antennas 26, 28 radiate as desired and to isolate the antennas 26, 28 from each other. Here, the top surface or face 82 of the groundplane 42 has a square shape. Two ends 86, 88 of the groundplane 42 extend away from the bottom surface 80 and inwardly toward each other. For example, for a sheet conductor groundplane, the ends 86, 88 may be folded to provide the shaped ends 86, 88 shown in FIG. 3. For a UMTS example, the groundplane could be about 6″ by about 6″, with the ends 86, 88 extending downwardly about 7 mm and inwardly about 5 mm. If a box groundplane is used, the thickness of the box could be about 40 mm.

The coverage antenna 28 comprises a balanced dipole antenna radiator. For example, here the dipole antenna 26 comprises a center-fed dipole etched on a 30-mil FR4 copper-clad printed circuit board sheet 90 available, for example, from ExpressPCB™. The dipole 28 is displaced from the top surface 82 of the groundplane 42. The dipole 28 is planar, with a plane in which the dipole 28 resides being transverse to a plane of the top surface 82 of the groundplane 42. Design parameters for the dipole 28 include a length 92 and a width 94 of the dipole 28. For a UMTS example, the length 92 can be about 64 mm and the width 94 can be about 6 mm. Further, a distal edge 29 of the dipole 28 is disposed a distance 102 that is substantially greater than the distance 100, e.g., at least 10%, 20%, 30%, 40%, 50%, 60%, 70%, 80%, 90%, 100%, 110%, 120%, 130%, 140%, or 150% greater. For example, the distance 102 may be about 2.5 times (150% greater than) the distance 100. Consequently, the distance 100 is substantially less than the distance 102. For a UMTS example, the distance 102 can be about 28.6 mm with the distance 100 about 11.8 mm. Opposing portions or arms 104, 106 of the dipole 28 are separated by a gap 108 that is fed by the coverage antenna feed arrangement 46. The slot 108 extends from the distal edge 29 toward the groundplane 42, but stops above the groundplane 42.

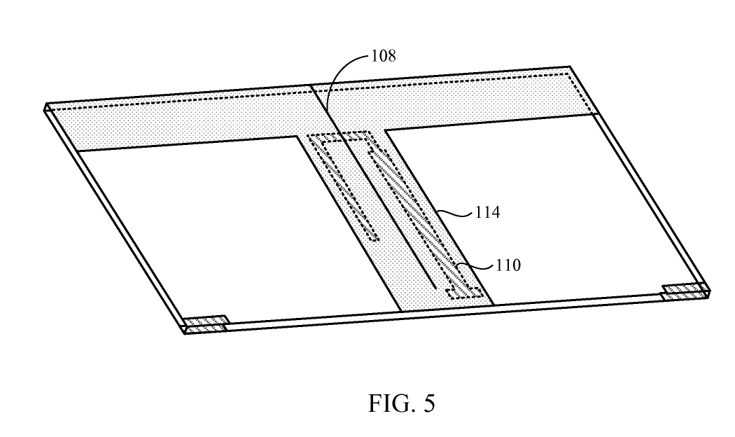

Referring also to FIG. 5, the coverage antenna feed arrangement 46 includes a microstrip line 110, and a coaxial cable 112. The cable 112 can be attached, e.g., soldered, to the groundplane 42. Other feed mechanisms could be used instead of the coaxial cable 112. The coaxial line 112 is attached to the top surface 82 of the groundplane 42, with a center conductor of the coaxial line electrically coupled to the microstrip 110. If a box groundplane is used, the coaxial line 112 could extend internally to the box, e.g., on an inner surface of a top wall and extend through the top wall to excite the microstrip 110 to in turn excite the radiator 28. The microstrip 110 is formed on the sheet 90 on the opposite side of the sheet as the dipole 28. A section 114 of copper is left on the same side of the sheet 90 as the dipole 28 to serve as a groundplane for the microstrip 110. The microstrip 110 has a J shape, extending from adjacent to the top surface 82 of the groundplane toward the dipole 28 on one side of the slot 108, traversing the slot 108, and extending back toward the groundplane 42 on the other side of the slot 108. The microstrip 110 includes a change in width to provide a quarter-wavelength impedance transformer to transition from about 75 ohms to about 50 ohms, with the impedance being about 50 ohms when the microstrip 110 traverses the slot 108.

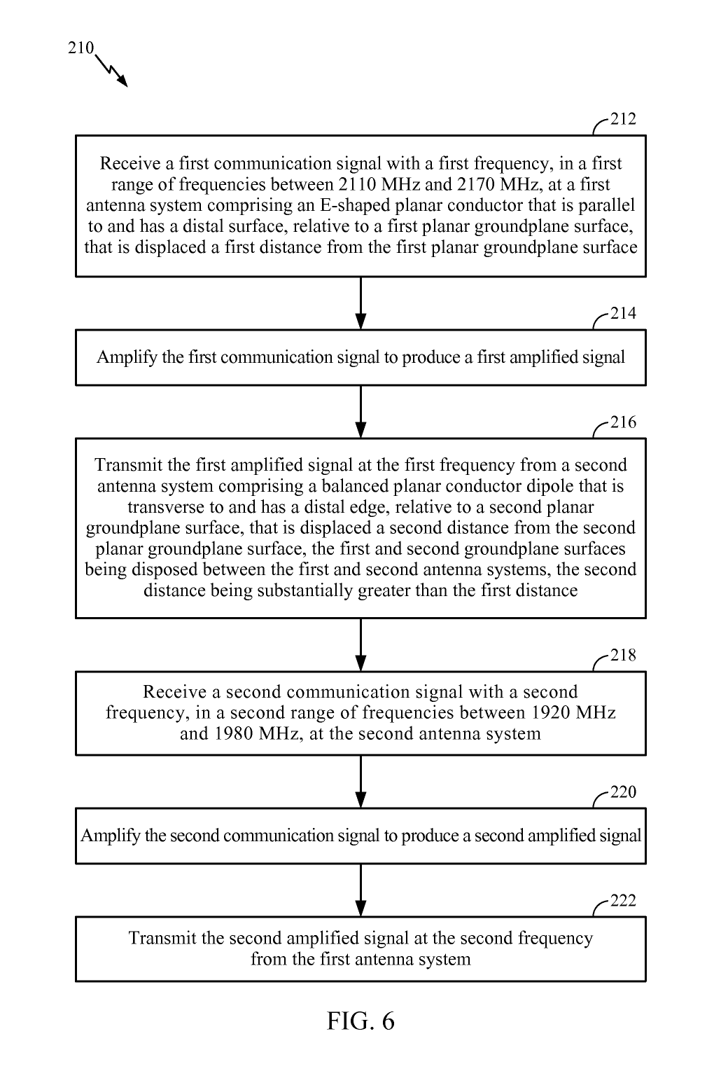

Referring to FIG. 6, with further reference to FIGS. 1-5, a process 210 of repeating Universal Mobile Telecommunications System (UMTS) communication signals includes the stages shown. The process 210 is, however, an example only and not limiting. The process 210 can be altered, e.g., by having stages added, removed, rearranged, combined, and/or performed concurrently. For example, the order of the stages shown is not required, with it possible to receive uplink signals before downlink signals, and/or to receive, amplify, and/or transmit uplink and downlink signals concurrently, and/or to have still other orders of stages.

At stage 212, a first communication signal is received. The first communication signal is a downlink (DL) communication signal and has a first frequency, in a first range of frequencies between 2110 MHz and 2170 MHz. The DL signal is received from a BTS 12 at the donor antenna system 26, in particular here the E-shaped planar conductor 26 that is parallel to and has a distal surface, relative to the planar groundplane surface 80, that is displaced the distance 100 from the planar groundplane surface 80.

At stage 214, the first communication signal is amplified to produce a first amplified signal. The amplifier 34 receives the DL signal from the donor antenna 26, amplifies this signal to produce an amplified DL (receive) signal, and outputs the amplified DL signal.

At stage 216, the amplified DL signal is transmitted. The amplified DL signal is provided at the first frequency from the amplifier 34 to the coverage antenna 28. The amplified DL signal is transmitted from the coverage antenna system 28, in particular here the balanced planar conductor dipole 28 that is transverse to and has the distal edge 29, relative to the planar groundplane surface 82, that is displaced the distance 102 from the second planar groundplane surface 82. The first and second groundplane surfaces 80, 82 are disposed between the first and second antenna systems 26, 28, and the second distance 102 being substantially greater than the first distance 100. The amplified DL signal is transmitted by the coverage antenna 28 for reception by one or more of the ATs 16.

At stage 218, a second communication signal is received. The second communication signal is an uplink (UL) communication signal and has a second frequency, in a second range of frequencies between 1920 MHz and 1980 MHz. The UL signal is received at the coverage antenna system 28 from an AT 16.

At stage 220, the UL communication signal is amplified to produce a second amplified signal. The amplifier 32 receives the UL signal from the coverage antenna 28, amplifies this signal to produce an amplified UL (transmit) signal, and outputs the amplified UL signal.

At stage 222, the amplified UL signal is transmitted. The amplified UL signal is provided at the second frequency from the amplifier 32 to the donor antenna system 26. The amplified UL signal is transmitted from the donor antenna system 26 for reception by one or more of the BTSs 12.

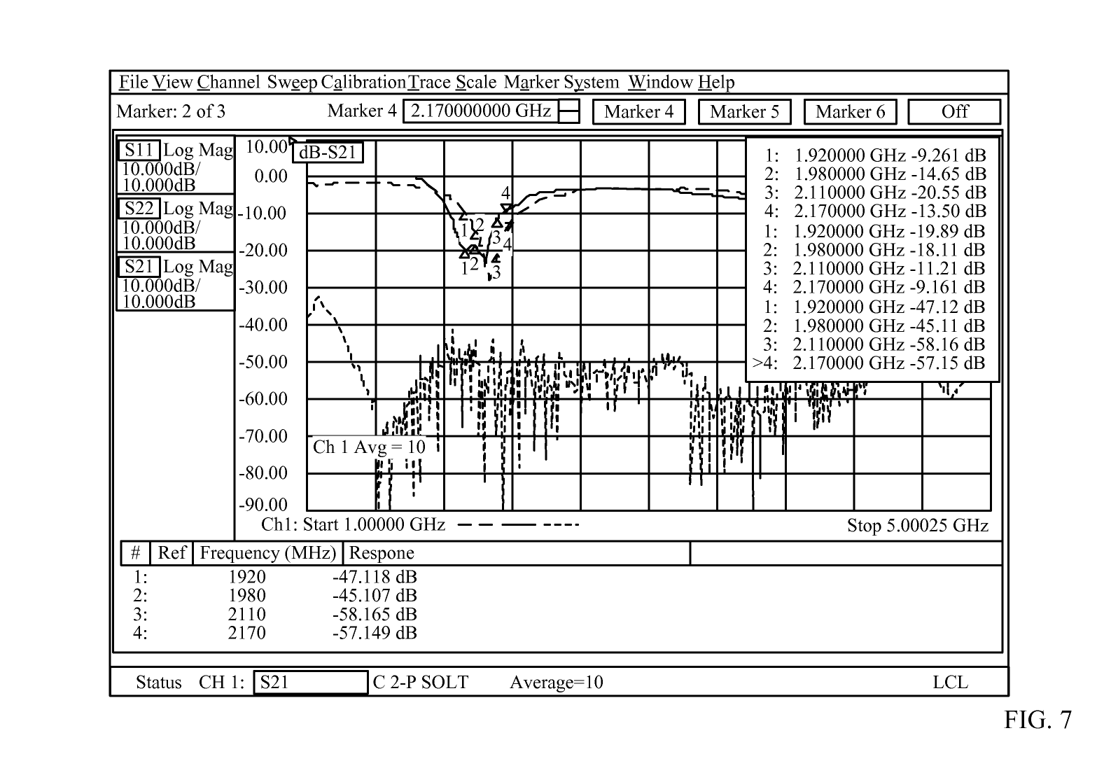

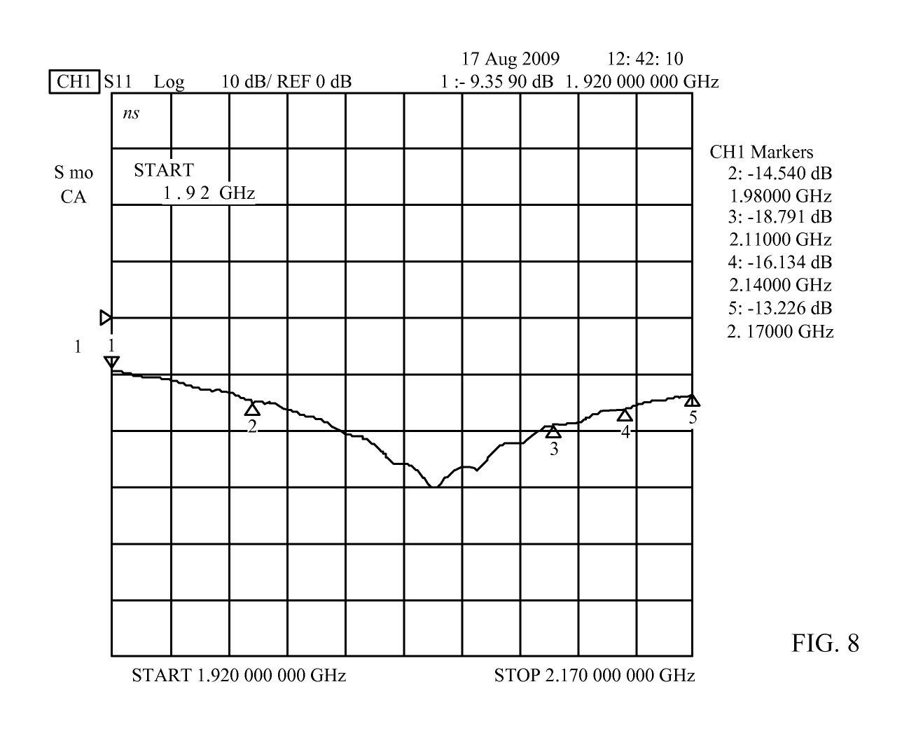

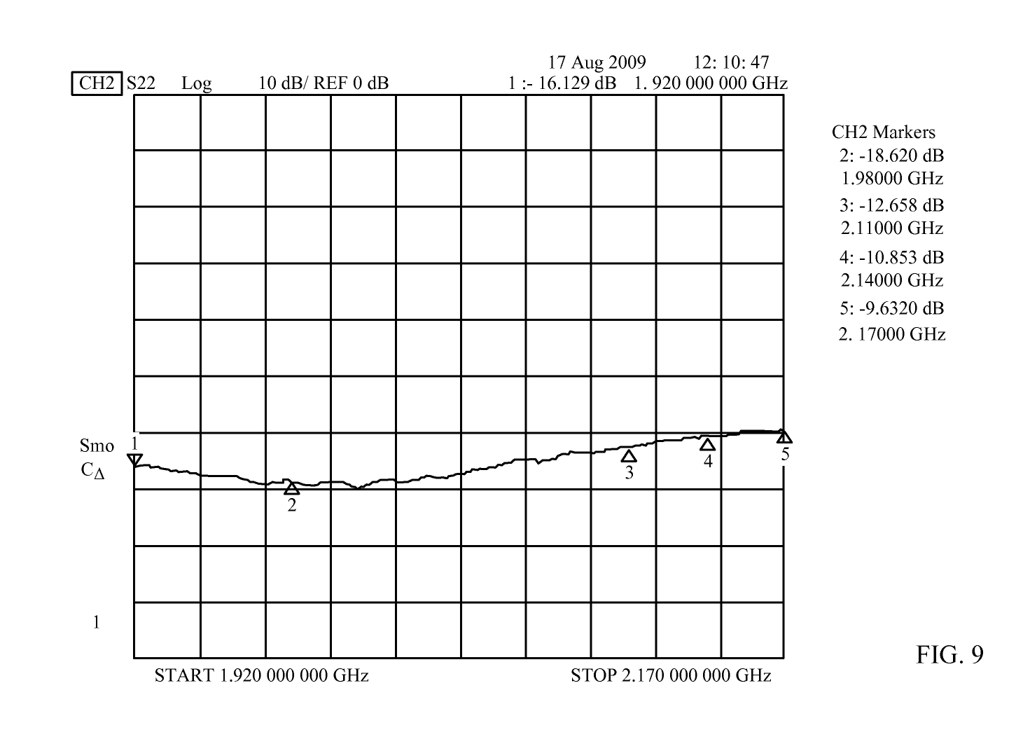

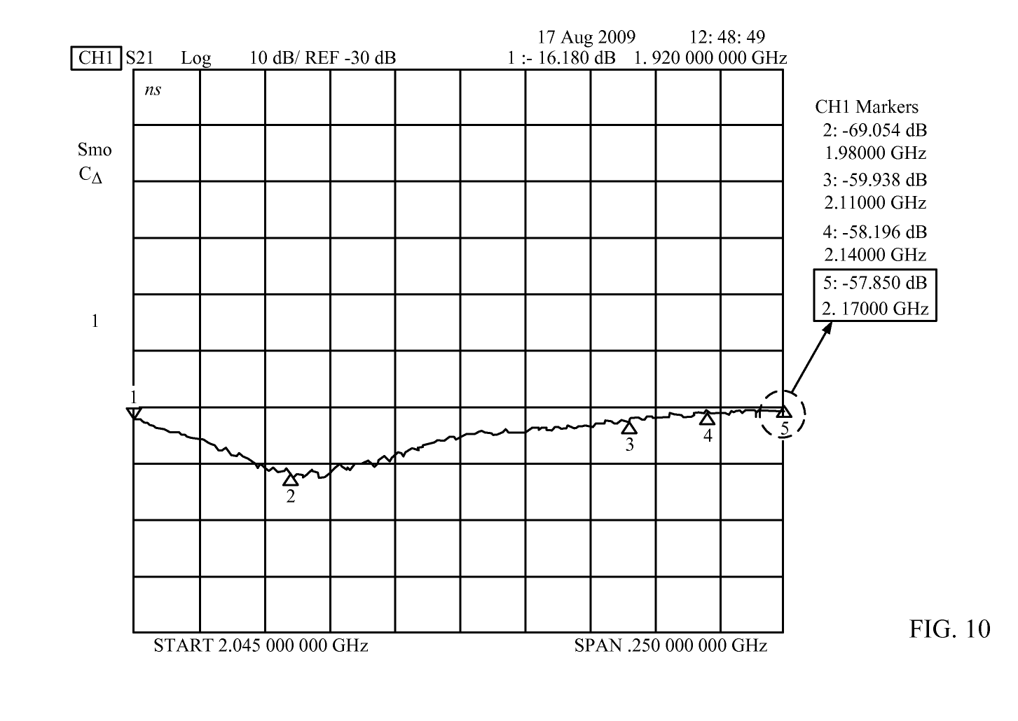

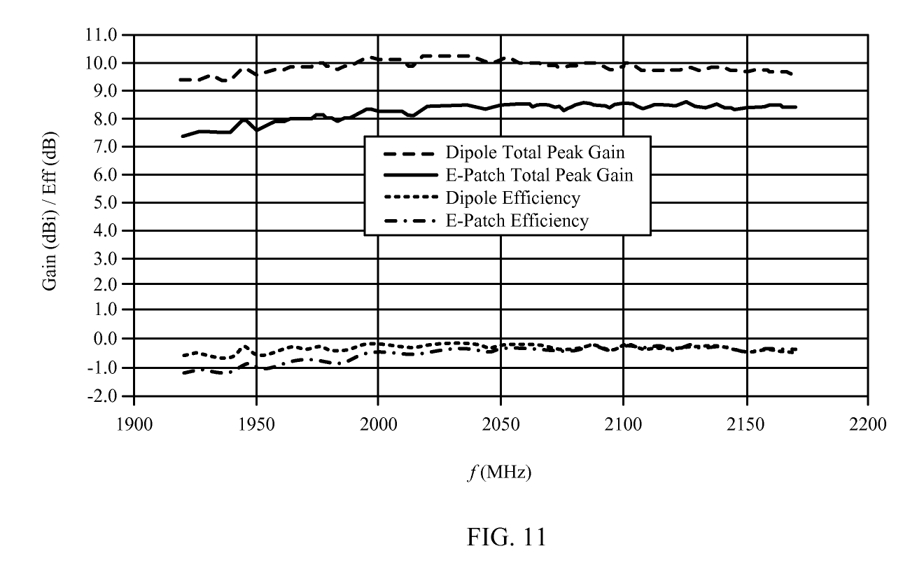

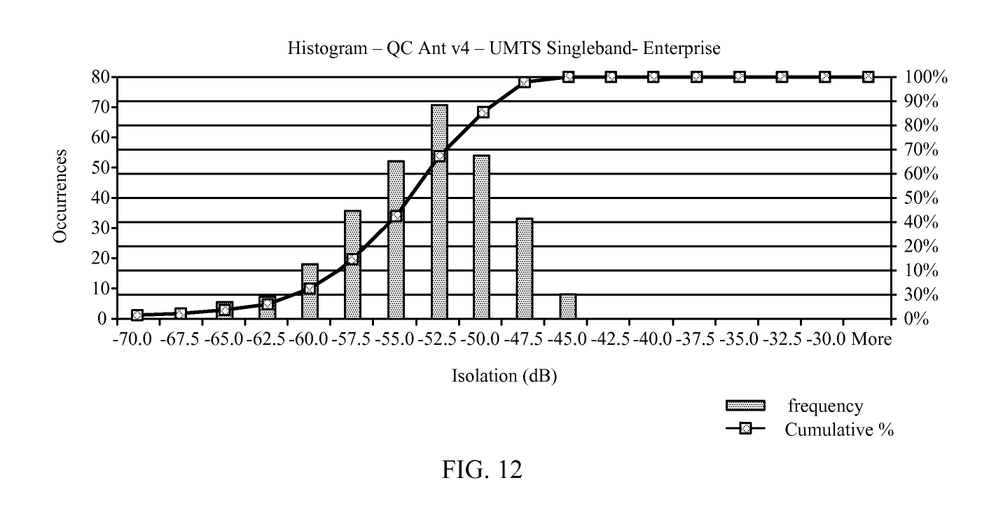

Referring to FIGS. 7-12, the antenna configuration 40 was modeled and built using materials and dimensions described above for a UMTS implementation. Referring to FIG. 7, lab-measured s-parameters showed return losses (S₁₁, S₂₂) are about 10 dB at the UMTS band edges of 1920 MHz and 2170 MHz, and less in between the band edges. Referring to FIG. 8, measured freespace return loss of the coverage antenna 28 was 9.35 dB (at 1920 MHz) or lower over the frequency range 1920 MHz-2170 MHz. Referring to FIG. 8, measured freespace return loss of the donor antenna 26 was 9.632 dB (at 2170 MHz) or lower over the frequency range 1920 MHz-2170 MHz. Referring to FIG. 10, measured freespace isolation was 57.85 dB (at 2170 MHz) or lower over the range 1920 MHz-2170 MHz. Referring to FIG. 11, measured peak gain of the donor antenna 26 was from about 9.2 dBi to about 10.3 dBi and measured peak gain of the coverage antenna 28 was from about 7.3 dBi to about 8.7 dBi over the range 1920 MHz-2170 MHz. Referring to FIG. 12, statistics are shown of isolation achieved when the antenna is placed in a real (enterprise) environment where electromagnetic waves are reflected and scattered by walls, ceiling, floor and other nearby objects. In this example, with the antenna (or repeater) functioning in an enterprise environment, 50% of the time the isolation is about 52.5 dB, and so on.

### Alternative Configurations

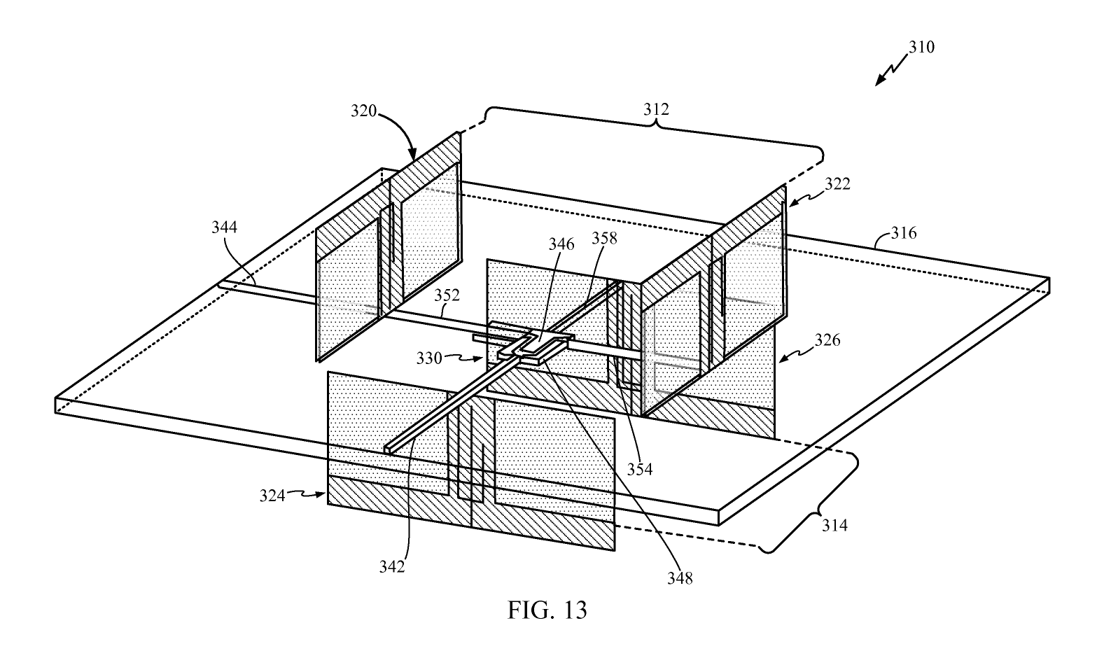

Other examples and implementations are within the scope and spirit of the disclosure and appended claims. For example, referring to FIG. 13, an antenna configuration 310 includes two-dipole antenna arrays 312, 314, each including two dipole antenna structures 320, 322, 324, 326, respectively. The dipole antenna structures 320, 322, 324, 326 are similar to the dipole 28 and feed arrangement 46 discussed above, and further described below. Here, the dipole antennas in the respective coverage and donor systems are parallel to each other and fed by microstrip feeds. The antennas of the two arrays 312, 314 are disposed transverse to each other and separated by a metal groundplane 316. Here, the groundplane 316 is a conductive sheet, but other configurations, such as a box with conductive surfaces, are possible. For each aperture (i.e., donor or coverage) a coaxial line 342, 344 extends from a perimeter of the groundplane 316 along one surface of the groundplane 316 to a center of the groundplane 316 between the dipole structures 320, 322, 324, 326. The coaxial lines 342, 344 are connected to power dividers 346, 348 that splits the coaxial lines 342, 344 into two coaxial lines 352, 354, 356, 358 that connect to two microstrip lines feeding the dipoles of the dipole structures 320, 322, 324, 326. The configurations discussed are examples and may be different from other architectures, e.g., if the antenna is part of the repeater. The power divider, for example, could be included in the repeater circuitry and each antenna connected to the “right” location on the RF board. In other words, the description above provides examples of ways to feed the antenna and are not the only ways the antenna could be fed. Further, other forms of power dividers and transmission lines can be used instead of coaxial cables. Alternatively, if the groundplane 316 has a thickness (e.g., a box), the coaxial cables 342, 344, 352, 354, 356, 358 could extend from the perimeter of the groundplane between the opposing sides of the groundplane (i.e., inside the groundplane box), and the power dividers 346, 348 could be housed by the box. Instead of coaxial lines, connection lines could be microstrip, CPW, or striplines and could be outside of a groundplane box or inside the groundplane box. Further electronics, e.g., amplifiers and an echo canceller (see FIG. 2) could also be housed by a groundplane box. The power dividers 346, 348 preferably evenly divide the power to the respective dipole structures 320, 322, 324, 326. For example, the power dividers 346, 348 may be 3 dB Wilkinson dividers.

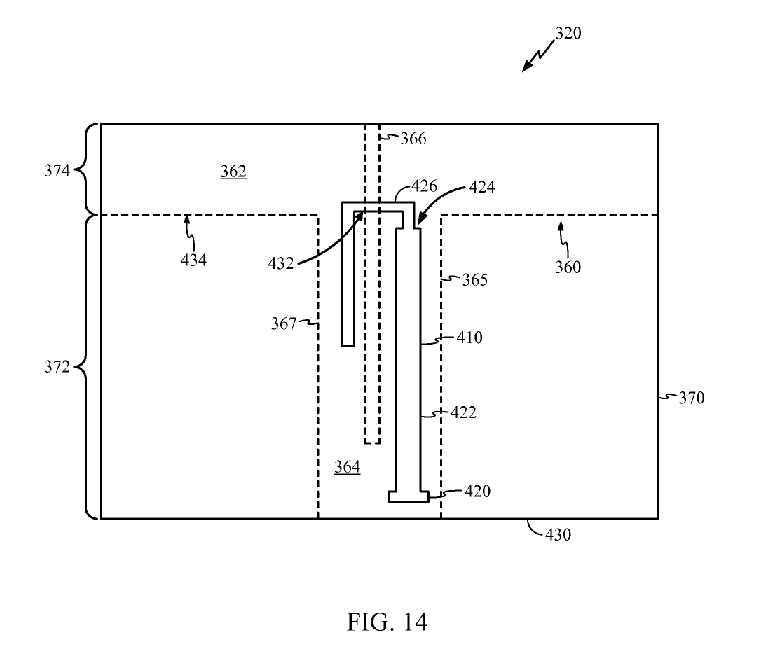

Referring also to FIG. 14, the dipole structure 320 includes a planar conductor 360, a dielectric structure 370, and a feed structure or feed conductor 410. The dipole structure 320 provides a dipole antenna 362 and a feed mechanism for the dipole antenna 362. The conductor 360 is disposed on the back side of the dielectric structure 370, and the feed structure 410 is disposed on the front side of the structure 370, as viewed in FIG. 14. The dipole structure 320 can have the dimensions discussed above for use in a UMTS deployment.

In this example, the planar conductor 360 has a T shape and includes the dipole antenna 362 and a feed groundplane portion 364. The dipole 362 is a balanced dipole, being divided into two equal, or roughly equal, portions that define a slot 366 extending through a center of the dipole 362. The feed groundplane portion 364 of the conductor 360 provides a groundplane for the feed structure 410, which combined with the dielectric 370 and the groundplane 360 is a microstrip line. The feed groundplane portion 364 is configured as a balun, being shaped symmetrically such that currents running on the portion 364 are differential and will thus not radiate. The portion 364 is configured to define the slot 366 to extend most, but not all, of a length of the portion 364 and to define the slot 366 down a middle of the portion 364 such that sub-portions 365, 367 are similarly shaped and extend along respective sides of the slot 366.

The feed structure 410 overlies the feed groundplane portion 364 of the planar conductor 360. The feed structure 410 includes a connection portion 420, a low-impedance portion 422, a transition 424, and a high-impedance portion 426. High and low impedance are relative, with the low-impedance portion 422 here being an impedance transformer and having an impedance of about 50Ω and the high-impedance portion 426 here having an impedance of about 75Ω. The transition 424 is a change in width of the feed structure 410 between the 50Ω width of the portion 422 and the 75Ω width of the portion 426. The connection portion 420 is disposed close to, but displaced from, a bottom edge 430 of the structure 320 to facilitate connection to a transmission line connected to signal repeating circuitry (see FIG. 2). The balun extends upwardly (as shown in FIG. 14) away from the bottom edge 430 (and thus the groundplane 316) along the right side of the slot 366. The portion 426 of the feed structure 410 extends transverse to the portion 422, traversing the slot 366 to induce a voltage in the slot 366 such that the portion 426 can electromagnetically excite (i.e., launch electromagnetic waves in) the slot 366. The portion 426 further has a bend such that the portion 426 extends downwardly toward the lower edge 430. The feed structure 410 thus has a J shape, with the feed structure 410 being an inverted, backwards J as seen in FIG. 14. A proximal edge 432 of the high-impedance portion 426 is coextensive with a proximal edge 434 of the dipole 362. The feed structure 410 is separated from the feed groundplane portion 364 and the dipole 362 by the dielectric material 370. The dipole is fed at the center gap 366 by a voltage induced by the microstrip line 426 going over the slot 366.

The dielectric material 370 has a corresponding dielectric constant value, which will affect the dimensions of the planar conductor 360 and the feed structure 410 to achieve desired radiation and impedance characteristics, respectively. Further, the dielectric material 370 may be of non-uniform dielectric constant value, while still being a single structure. For example, a feed portion 372 of the material 370 may have one dielectric constant value while an antenna portion 374 of the material 370 may have a dielectric constant value that is different from the value of the feed portion 372. The structure 320 may be formed by etching a single sheet of material with plating on both sides, and with a single dielectric constant.

The antenna configuration 310 can be used as a repeater 24 in a process similar to the process 210 described above. The description above would be modified to reflect the lack of an E-shaped patch antenna, and the existence of the two dipole arrays 312, 314.

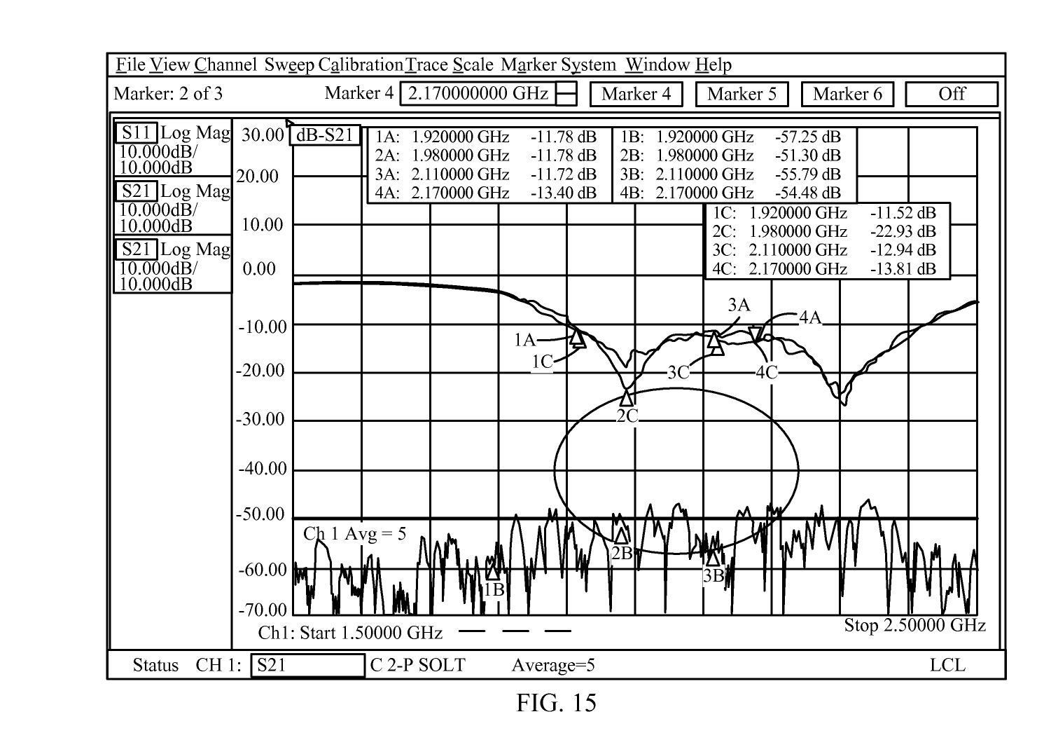

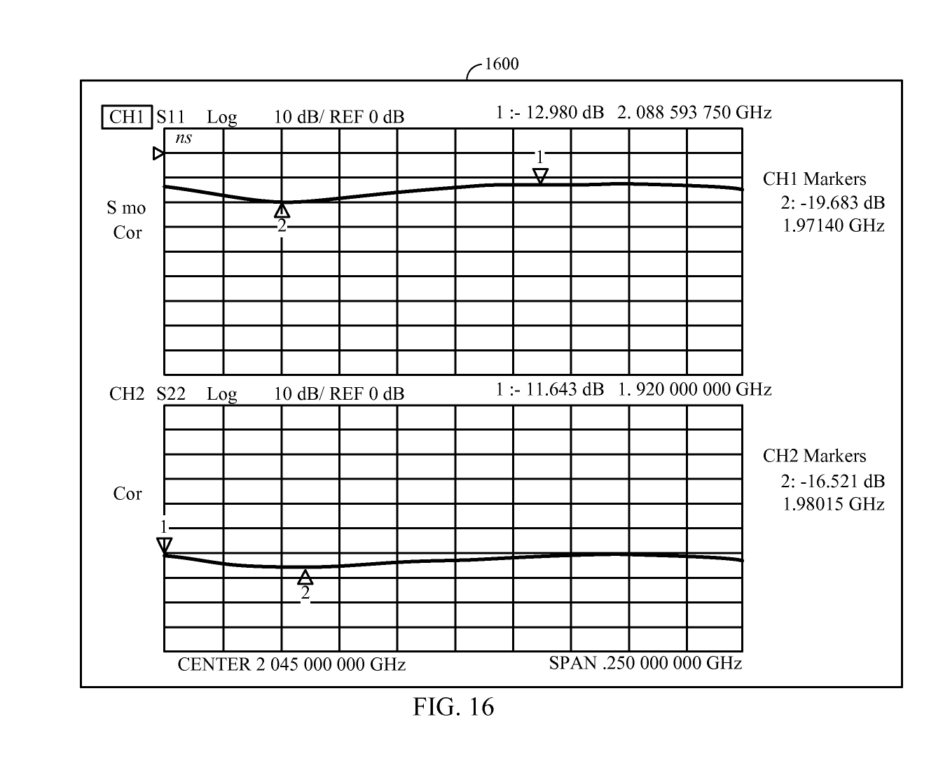

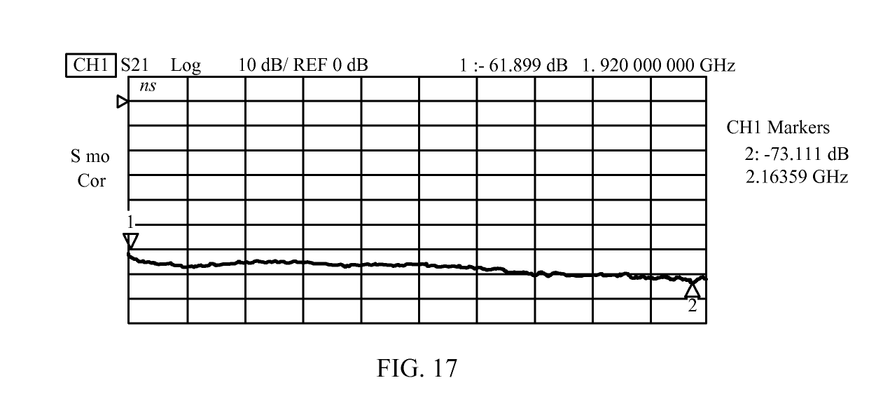

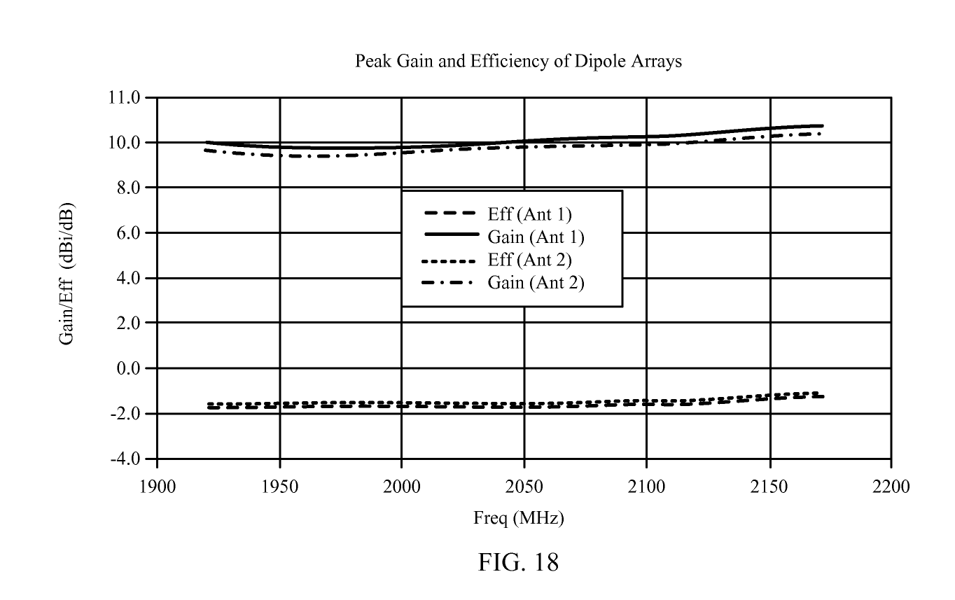

Referring to FIGS. 15-18, the antenna configuration 310 was modeled and built using materials and dimensions described above for a UMTS implementation. Referring to FIG. 15, lab-measured s-parameters showed return losses (S₁₁, S₂₂) of less than about −12 dB across the UMTS band of 1920 MHz-2170 MHz. Referring to FIG. 16, measured freespace return loss was also less than about −12 dB across the UMTS band. Referring to FIG. 17, measured freespace isolation was less than about −62 dB across the UMTS band. Referring to FIG. 18, measured peak gains of the dipole antenna arrays 312, 314 were both about 10 dB across the UMTS band.

Still further implementations and configurations are possible. While FIG. 3 shows a E-patch donor antenna and a dipole coverage antenna, and FIG. 13 shows 2-dipole arrays for both a donor antenna system and a coverage antenna system, other arrangements are possible, e.g., with at least one of the donor or coverage antenna systems using a dipole antenna.

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims. Further, more than one invention may be disclosed.

What is claimed is:

1. An on-frequency repeater comprising:
a groundplane having first and second opposing surfaces on first and second sides of the groundplane, respectively, the groundplane comprising an electrical conductor; and
an antenna system comprising a plurality of directional antennas of different types, the antenna system comprising:
a donor antenna array comprising a plurality of donor dipoles disposed on the first side of the groundplane and displaced a first distance from the first surface, the donor dipoles being disposed parallel to each other;
a coverage antenna array comprising a plurality of coverage dipoles disposed on the second side of the groundplane and displaced a second distance from the second surface, the coverage dipoles being disposed parallel to each other and transverse to the donor dipoles;
a plurality of baluns and a corresponding plurality of feed conductors extending away from the groundplane and configured to electromagnetically feed respective ones of the donor dipoles and coverage dipoles.

2. The repeater of claim 1 wherein the donor dipoles each comprise a rectangular planar conductor disposed in a plane transverse to a plane of the first surface, and the coverage dipoles each comprise a rectangular planar conductor disposed in a plane transverse to a plane of the second surface.

3. The repeater of claim 2 wherein each of the dipoles is a balanced dipole defining a slot bisecting the planar conductor, and wherein the respective feed conductors traverse and excite the respective slots.

4. The repeater of claim 3 wherein each of the baluns extends from the respective dipole toward the groundplane and defines the respective slot from the dipole toward the groundplane, wherein each of the feed conductors extends away from the groundplane toward the respective dipole on a first side of the respective slot and traverses the slot while overlapping a portion of the respective dipole.

5. The repeater of claim 4 wherein each of the feed conductors traverses the respective slot near a proximal edge of the respective dipole, the proximal edge being closer to the groundplane than a distal edge of the respective dipole.

6. The repeater of claim 4 wherein each of the feed conductors has a J shape, extending toward the groundplane on a second side of the respective slot, opposite the first side of the respective slot.

7. The repeater of claim 1 wherein the donor dipoles and the coverage dipoles are configured to have lower return losses inside a range of frequencies from 1920 MHz-2170 MHz than outside the range of frequencies, and wherein both the donor antenna array and the coverage antenna array provide at least 10 dB of return loss over the range of frequencies

8. The repeater of claim 1 wherein each of the donor and coverage dipoles and the respective balun are disposed on a sheet of dielectric material.

9. The repeater of claim 8 wherein respective first portions of the dielectric material on which the baluns are disposed have a first dielectric constant value and respective second portions of the dielectric material on which the dipoles are disposed have a second dielectric constant value, the first and second dielectric constant values being different.

10. An on-frequency repeater comprising:
a groundplane structure providing an internal cavity and having first and second opposing conductive surfaces on first and second sides of the groundplane structure, respectively;
a donor antenna system disposed on the first side of the groundplane, the donor antenna system having a first directional antenna pattern; and
a coverage antenna system disposed on the second side of the groundplane, the coverage antenna system having a second directional antenna pattern;
wherein at least one of the donor antenna system or the coverage antenna system comprises a dipole antenna electrically coupled to a balun wherein the dipole antenna comprises a first planar conductor disposed on a dielectric structure and the balun comprises a second planar conductor disposed on the same dielectric structure.

11. The repeater of claim 10 wherein the dipole antenna is disposed on a first portion of the dielectric structure having a first dielectric constant value and at least a portion of the balun is disposed on a second portion of the dielectric structure having a second dielectric constant value, the first and second dielectric constant values being different.

12. The repeater of claim 10 further comprising a plurality of amplifiers and an echo canceller, all electrically coupled to the donor and coverage antenna systems, wherein the amplifiers and the echo canceller are housed in the groundplane structure.
